(19) United States
(12) Patent Application Publication
(10) Pub. No.: US 2026/0017921 A1
(43) Pub. Date: Jan. 15, 2026

(54) PROCESSING IMAGES USING TEMPORALLY-PROPAGATED CLUSTER MAPS

(71) Applicant: QUALCOMM TECHNOLOGIES, INC., San Diego, CA (US)

(72) Inventors: Mohammadreza SALEHI, Amsterdam (NL); Efstratios GAVVES, Amsterdam (NL); Cornelis Gerardus Maria SNOEK, Volendam (NL); Yuki Markus ASANO, Amsterdam (NL)

(21) Appl. No.: 19/114,394

(22) PCT Filed: Sep. 6, 2023
(86) PCT No.: PCT/US2023/073554

§ 371 Date: Mar. 21, 2025

(30) Foreign Application Priority Data
Nov. 11, 2022 (GR) 20220100929

(51) Int. Cl. G06V 10/762; G06N 20/00; G06V 10/44; G06V 10/74

(52) U.S. Cl. CPC G06V 10/762; G06N 20/00; G06V 10/44; G06V 10/761

(57) ABSTRACT

Systems and techniques are provided for processing image data. For example, a process can include processing a source image to generate a first features for the source image and a target image to generate a second features for the target image. The process can include generating a first cluster map for the source image based on prototypes and the first features for the source image, and generating a second cluster map for the target image based on the prototypes and the second features for the target image. The process can include determining a propagated cluster map for the source image based on the first cluster map and a correspondence between regions of the source image and regions of the target image. The process can include determining a loss based on a comparison of the propagated cluster map for the source image and the second cluster map for the target image.

### FIELD

The present disclosure generally relates to image processing. For example, aspects of the present disclosure are related to systems and techniques for processing images using temporally-propagated cluster maps.

### BACKGROUND

Many devices and systems allow a scene to be captured by generating images (or frames) and/or video data (including multiple frames) of the scene. For example, a camera or a device including a camera can capture a sequence of frames of a scene (e.g., a video of a scene). In some cases, the sequence of frames can be processed for performing one or more functions, can be output for display, can be output for processing and/or consumption by other devices, among other uses.

An artificial neural network attempts to replicate, using computer technology, logical reasoning performed by the biological neural networks that constitute animal brains. Deep neural networks, such as convolutional neural networks, are widely used for numerous applications, such as object detection, object classification, object tracking, big data analysis, among others. For example, convolutional neural networks are able to extract high-level features, such as facial shapes, from an input image, and use these high-level features to output a probability that, for example, an input image includes a particular object.

### BRIEF SUMMARY

In some examples, systems and techniques are described for processing images using temporally-propagated cluster maps. According to at least one illustrative example, a method is provided for processing image data. The method includes: processing, using a machine learning model, a source image of the image data to generate a first set of features for the source image: processing, using the machine learning model, a target image to generate a second set of features for the target image: generating a first cluster map for the source image based on a set of prototypes and the first set of features for the source image: generating a second cluster map for the target image based on the set of prototypes and the second set of features for the target image: determining a propagated cluster map for the source image based on the first cluster map and a correspondence between a plurality of regions of the source image and a plurality of regions of the target image; and determining a loss based on a comparison of the propagated cluster map for the source image and the second cluster map for the target image.

In another illustrative example, an apparatus is provided that can process image data. The apparatus includes one or more memories configured to store the image data and one or more processors coupled to the one or more memories and configured to: process, using a machine learning model, a source image to generate a first set of features for the source image; process, using the machine learning model, a target image to generate a second set of features for the target image: generate a first cluster map for the source image based on a set of prototypes and the first set of features for the source image: generate a second cluster map for the target image based on the set of prototypes and the second set of features for the target image: determine a propagated cluster map for the source image based on the first cluster map and a correspondence between a plurality of regions of the source image and a plurality of regions of the target image; and determine a loss based on a comparison of the propagated cluster map for the source image and the second cluster map for the target image.

In another illustrative example, a non-transitory computer-readable storage medium comprising instructions stored thereon which, when executed by one or more processors, causes the one or more processors to: process, using a machine learning model, a source image to generate a first set of features for the source image: process, using the machine learning model, a target image to generate a second set of features for the target image: generate a first cluster map for the source image based on a set of prototypes and the first set of features for the source image: generate a second cluster map for the target image based on the set of prototypes and the second set of features for the target image: determine a propagated cluster map for the source image based on the first cluster map and a correspondence between a plurality of regions of the source image and a plurality of regions of the target image; and determine a loss based on a comparison of the propagated cluster map for the source image and the second cluster map for the target image.

In another illustrative example, an apparatus is provided for processing image data. The apparatus includes: means for processing, using a machine learning model, a source image to generate a first set of features for the source image: processing, using the machine learning model, a target image to generate a second set of features for the target image: generating a first cluster map for the source image based on a set of prototypes and the first set of features for the source image: generating a second cluster map for the target image based on the set of prototypes and the second set of features for the target image: determining a propagated cluster map for the source image based on the first cluster map and a correspondence between a plurality of regions of the source image and a plurality of regions of the target image; and determining a loss based on a comparison of the propagated cluster map for the source image and the second cluster map for the target image.

In some aspects, one or more of the apparatuses described herein is, is part of, and/or includes an extended reality (XR) device or system (e.g., a virtual reality (VR) device, an augmented reality (AR) device, or a mixed reality (MR) device), a mobile device (e.g., a mobile telephone or other mobile device), a wearable device, a wireless communication device, a camera, a personal computer, a laptop computer, a vehicle or a computing device or component of a vehicle, a server computer or server device (e.g., an edge or cloud-based server, a personal computer acting as a server device, a mobile device such as a mobile phone acting as a server device, an XR device acting as a server device, a vehicle acting as a server device, a network router, or other device acting as a server device), another device, or a combination thereof. In some aspects, the apparatus includes a camera or multiple cameras for capturing one or more images. In some aspects, the apparatus further includes a display for displaying one or more images, notifications, and/or other displayable data. In some aspects, the apparatuses described above can include one or more sensors (e.g., one or more inertial measurement units (IMUs), such as one or more gyroscopes, one or more gyrometers, one or more accelerometers, any combination thereof, and/or other sensor.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

Illustrative embodiments of the present application are described in detail below with reference to the following drawing figures:

FIG. 1 illustrates an example implementation of a system-on-a-chip (SoC), in accordance with some examples;

FIG. 2A illustrates an example of a fully connected neural network, in accordance with some examples;

FIG. 2B illustrates an example of a locally connected neural network, in accordance with some examples;

FIG. 3 is a diagram illustrating an example machine learning architecture that can be used to process images using temporally-propagated cluster maps, in accordance with some examples;

FIG. 4 is a diagram illustrating an example machine learning architecture that can be used to process images using temporally-propagated cluster maps, in accordance with some examples; and

FIG. 5 is a flow diagram illustrating an example of a process for processing image and/or video data, in accordance with some examples; and

FIG. 6 is a block diagram illustrating an example of a computing system for implementing certain aspects described herein.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

Image semantic segmentation is a task of generating segmentation results for a frame of image data, such as a still image or photograph. Video semantic segmentation is a type of image segmentation that includes a task of generating segmentation results for one or more frames of a video (e.g., segmentation results can be generated for all or a portion of the image frames of a video). Image semantic segmentation and video semantic segmentation can be collectively referred to as “image segmentation” or “image semantic segmentation.” Segmentation results can include one or more segmentation masks generated to indicate one or more locations, areas, and/or pixels within a frame of image data that belong to a given semantic segment (e.g., a particular object, class of objects, etc.). For example, each pixel of a segmentation mask can include a value indicating a particular semantic segment (e.g., a particular object, class of objects, etc.) to which each pixel belongs.

In some cases, image segmentation can be performed to segment image frames into segmentation masks based on an object classification scheme (e.g., the pixels of a given semantic segment all belong to the same classification or class). For example, one or more pixels of an image frame can be segmented into classifications such as human, hair, skin, clothes, house, bicycle, bird, background, etc. In some examples, a segmentation mask can include a first value for pixels that belong to a first classification, a second value for pixels that belong to a second classification, etc. A segmentation mask can also include one or more classifications for a given pixel. For example, a “human” classification can have sub-classifications such as ‘hair,’ ‘face,’ or ‘skin,’ such that a group of pixels can be included in a first semantic segment with a ‘face’ classification and can also be included in a second semantic segment with a ‘human’ classification.

Segmentation masks can be used to apply one or more processing operations to a frame of image data. For example, a system may perform image augmentation and/or image enhancement for a frame of image data based on a semantic segmentation mask generated for the frame of image data. In one example, the system may process certain portions of a frame with a particular effect but may not apply the effect to a portion of the frame corresponding to a particular class indicated by a segmentation mask for the frame. Image augmentation and enhancement processes can include, but are not limited to, personal beautification, such as skin smoothing or blemish removal: background replacement or blurring: providing an extended reality (XR) or augmented reality (AR) experience; etc. Semantic segmentation masks can also be used to manipulate certain objects or segments in a frame of image data, for example by using the semantic segmentation mask to identify the pixels in the image frame that are associated with the object or portions to be manipulated. In one example, background objects in a frame can be artificially blurred to visually separate them from an in-focus or foreground object of interest (e.g., a person's face) identified by a segmentation mask for the frame (e.g., an artificial bokeh effect can be generated and applied based on the segmentation mask), where the object of interest is not blurred. In

In some examples, one or more machine learning networks can be used to perform segmentation (e.g., image segmentation and/or video segmentation). For example, features can be extracted from an image frame and used to generate one or more segmentation masks for the image frame based on the extracted features. In some cases, one or more machine learning networks can be used to generate segmentation masks based on the extracted features. For example, a convolutional neural network (CNN) can be trained to perform segmentation by inputting into the CNN many training images and providing a known output (or label) for each training image. The known output for each training image can include a ground-truth segmentation mask corresponding to a given training image.

In some examples, the use of labeled (e.g., annotated) segmentation information can be referred to as supervised training. For example, a machine learning network trained using labeled segmentation information is supervised based on the labels (e.g., annotations). In some cases, performing labeling to generate a sufficiently large training set can be a complex process. For example, supervised learning semantic segmentation performed in the video domain (e.g., video segmentation) may require additional manual labeling, based on the additional time dimension over which labels must be provided or maintained. In some examples, a machine learning network trained to perform a segmentation task based on a given set of labeled segmentation training data may also be limited and/or biased based on the content of the labels that are included in the training set.

In some cases, unsupervised training can be used to train a machine learning network to perform segmentation. For example, unsupervised semantic segmentation can be implemented based on training one or more machine learning networks in a self-supervised (e.g., unsupervised) manner, without providing labels or annotations. During self-supervised training for semantic segmentation, the one or more machine learning networks can learn to automatically determine semantically coherent areas in a set of training images and/or can learn to generate a segmentation output (e.g., a segmentation map, etc.) associated with one or more semantically coherent areas.

In some examples, existing approaches for unsupervised semantic segmentation have focused on the image domain, wherein an unsupervised machine learning network can be trained (e.g., using a self-supervision process) to automatically discover semantically coherent areas in images. For example, semantic segmentation performed in the image domain may utilize an augmentation-invariance assumption, wherein input images for segmentation are treated as discrete inputs that are not temporally linked to one or more other input images. In some aspects, video domain semantic segmentation that is performed based on augmentation-invariance may not account for various dynamics and/or temporal effects that are present in video data.

For example, a video data input can include a plurality of different still image frames, with one or more temporal variations between various sets or pairs of frames. The temporal variations can be based on or associated with camera movements: object shape deformations; changes to a camera zoom, aperture, and/or other properties: etc. There is a need for systems and techniques that can be used to perform unsupervised video semantic segmentation (e.g., semantic segmentation in the video domain) with improved accuracy. There is also a need for systems and techniques that can be used to perform unsupervised video semantic segmentation for video data inputs that include one or more temporal variations between frames.

Systems, apparatuses, processes (also referred to as methods), and computer-readable media (collectively referred to as “systems and techniques”) are described herein for processing images (e.g., image data or video data) using temporally-propagated cluster maps. For example, the systems and techniques can be used to perform unsupervised semantic segmentation based on using temporally-propagated cluster maps. In some examples, the temporally-propagated cluster maps can be utilized as a time-based supervision signal for the unsupervised semantic segmentation. The systems and techniques can also be used to perform other operations or tasks, such as object detection, depth estimation, or other operation or task.

For example, the systems and techniques can provide a temporal fine-tuning operator, which can be used to add temporal consistency to a pre-trained model (e.g., a neural network trained solely on images). In some cases, the systems and techniques can address a dense image segmentation task. In some aspects, one or more pre-trained vision transformers (ViTs) can be utilized. ViTs can be used to maintain the spatial relationship of input patches in the final patch representations. The systems and techniques can fine-tune patch representations to contain object part information, which can be used for a further downstream task (e.g., a segmentation task). In some examples, to perform the fine-tuning, the systems and techniques can force the representations of different views of an input image to be highly similar across time.

In some cases, detecting different views of the same objects in different frames can be challenging. In some examples, the systems and techniques can address this issue based on utilizing the temporal smoothness of video data to detect different views of the same object(s) in different frames. In some cases, temporally smooth video data may include relatively smooth movements or changes in pixel data between consecutive frames (e.g., the difference between consecutive frames may be relatively small or minor, and may not include abrupt jumps, movements, visual discontinuities, etc.)

For example, based on the temporal smoothness aspect of video data, the systems and techniques can treat each spatial location or patch included in an input space (e.g., image, frame, or portion thereof) as being movable only within a local window during consecutive frames and/or frames with a relatively small temporal separation. The local window of movement can be centered about the spatial location or patch in the input space. Based on confining the movement of spatial locations or patches to be within a local window; the systems and techniques can be used to implement unsupervised (e.g., self-supervised) semantic segmentation in the video domain. For instance, the semantic segmentation can be implemented based on limiting the similarities of patch-representations of different frames to a local window, where the local window is likely to represent the same content over the different frames (e.g., the same semantic content and/or semantic information).

In some aspects, the systems and techniques can obtain one or more patch representations associated with an input image or video data. For instance, the one or more patch representations can be obtained from and/or generated by a pre-trained machine learning model, such as a ViT and/or ViT-based machine learning model. Based on tracking patch locations in the local windows of temporally close frames (e.g., adjacent frames in time, etc.), different object views can be detected across time. Based on determining different views of the same object, the systems and techniques can train a head (e.g., a multi-laver perceptron (MLP)) of a machine learning system associated with the pre-trained model used to obtain the patch representations. The MLP or other machine learning head can be trained to generate output representations of objects that maximize local similarity (e.g., within the frame) and global similarity (e.g., across the whole training set). In some aspects, a self-supervised approach (e.g., Swapping Assignments between multiple Views of the same image (SwAV)) may be used on patch representations instead of image representations.

Various aspects of the present disclosure will be described with respect to the figures.

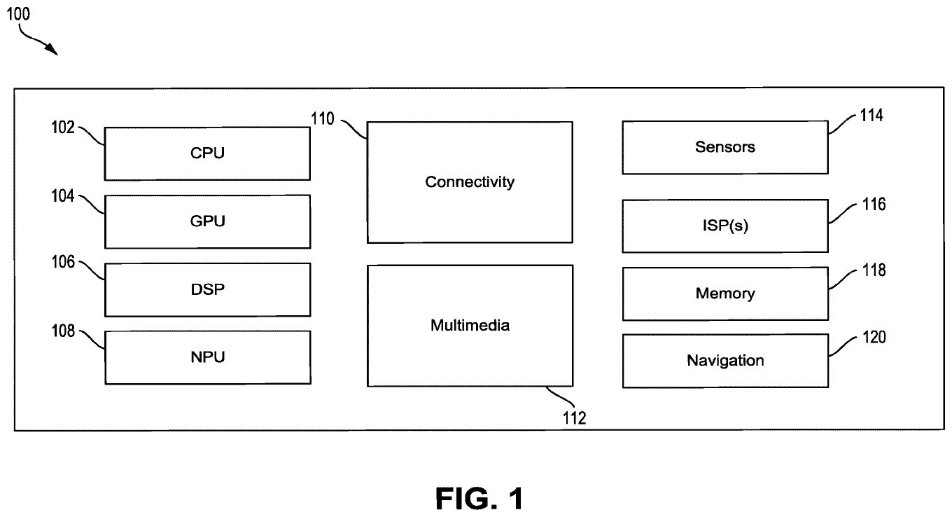

FIG. 1 illustrates an example implementation of a system-on-a-chip (SOC) 100, which may include a central processing unit (CPU) 102 or a multi-core CPU, configured to perform one or more of the functions described herein. Parameters or variables (e.g., neural signals and synaptic weights), system parameters associated with a computational device (e.g., neural network with weights), delays, frequency bin information, task information, among other information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, and/or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU is implemented in the CPU 102. DSP 106, and/or GPU 104. The SOC 100 may also include a sensor processor 114, image signal processors (ISPs) 116, and/or navigation module 120, which may include a global positioning system.

The SOC 100 may be based on an ARM instruction set. In an aspect of the present disclosure, the instructions loaded into the CPU 102 may comprise code to search for a stored multiplication result in a lookup table (LUT) corresponding to a multiplication product of an input value and a filter weight. The instructions loaded into the CPU 102 may also comprise code to disable a multiplier during a multiplication operation of the multiplication product when a lookup table hit of the multiplication product is detected. In addition, the instructions loaded into the CPU 102 may comprise code to store a computed multiplication product of the input value and the filter weight when a lookup table miss of the multiplication product is detected.

SOC 100 and/or components thereof may be configured to perform image processing using machine learning techniques according to aspects of the present disclosure discussed herein. For example, SOC 100 and/or components thereof may be configured to perform semantic image segmentation according to aspects of the present disclosure. In some cases, by using neural network architectures such as a transformer and/or vision transformer (ViT) in determining one or more segmentation masks, aspects of the present disclosure can increase the accuracy and efficiency of semantic image segmentation.

In general, ML can be considered a subset of artificial intelligence (AI). ML systems can include algorithms and statistical models that computer systems can use to perform various tasks by relying on patterns and inference, without the use of explicit instructions. One example of a ML system is a neural network (also referred to as an artificial neural network), which may include an interconnected group of artificial neurons (e.g., neuron models). Neural networks may be used for various applications and/or devices, such as image and/or video coding, image analysis and/or computer vision applications, Internet Protocol (IP) cameras, Internet of Things (IoT) devices, autonomous vehicles, service robots, among others.

Individual nodes in a neural network may emulate biological neurons by taking input data and performing simple operations on the data. The results of the simple operations performed on the input data are selectively passed on to other neurons. Weight values are associated with each vector and node in the network, and these values constrain how input data is related to output data. For example, the input data of each node may be multiplied by a corresponding weight value, and the products may be summed. The sum of the products may be adjusted by an optional bias, and an activation function may be applied to the result, yielding the node's output signal or “output activation” (sometimes referred to as a feature map or an activation map). The weight values may initially be determined by an iterative flow of training data through the network (e.g., weight values are established during a training phase in which the network learns how to identify particular classes by their typical input data characteristics).

Different types of neural networks exist, such as convolutional neural networks (CNNs), recurrent neural networks (RNNs), generative adversarial networks (GANs), multilayer perceptron (MLP) neural networks, transformer neural networks, among others. For instance, convolutional neural networks (CNNs) are a type of feed-forward artificial neural network. Convolutional neural networks may include collections of artificial neurons that each have a receptive field (e.g., a spatially localized region of an input space) and that collectively tile an input space. RNNs work on the principle of saving the output of a layer and feeding this output back to the input to help in predicting an outcome of the layer. A GAN is a form of generative neural network that can learn patterns in input data so that the neural network model can generate new synthetic outputs that reasonably could have been from the original dataset. A GAN can include two neural networks that operate together, including a generative neural network that generates a synthesized output and a discriminative neural network that evaluates the output for authenticity. In MLP neural networks, data may be fed into an input layer, and one or more hidden layers provide levels of abstraction to the data. Predictions may then be made on an output layer based on the abstracted data.

Deep learning (DL) is one example of a machine learning technique and can be considered a subset of ML. Many DL approaches are based on a neural network, such as an RNN or a CNN, and utilize multiple layers. The use of multiple layers in deep neural networks can permit progressively higher-level features to be extracted from a given input of raw data. For example, the output of a first layer of artificial neurons becomes an input to a second layer of artificial neurons, the output of a second layer of artificial neurons becomes an input to a third layer of artificial neurons, and so on. Layers that are located between the input and output of the overall deep neural network are often referred to as hidden layers. The hidden layers learn (e.g., are trained) to transform an intermediate input from a preceding layer into a slightly more abstract and composite representation that can be provided to a subsequent laver, until a final or desired representation is obtained as the final output of the deep neural network.

A transformer is a type of deep learning model that utilizes an attention mechanism to differentially weight the significance of each part of the input data and model long-range dependencies. For example, transformers can use an attention mechanism to determine global dependencies between input and output sequences. While transformers are often used to handle sequential input data, a transformer does not necessarily process the data in the same sequential order in which the data was originally received or arranged. Moreover, because transformers can use attention to determine contextual relationships between sub-portions of the input data, a transformer can process some (or all) of the sub-portions in parallel, such as when computing attention, self-attention, and/or cross-attention. This parallelization can provide greater computational flexibility in comparison to, for example, recurrent neural networks (RNNs), CNNs, or other neural networks trained to perform the same task. Transformer-based machine learning networks can be used to perform visual perception tasks based on input image data that includes a single view (e.g., a static and/or non-spatially distributed input image data). Transformer-based machine learning networks can also be used to perform visual perception tasks based on input image data that includes multiple views (e.g., multi-camera and/or spatially distributed input image data).

As noted above, a neural network is an example of a machine learning system, and can include an input layer, one or more hidden layers, and an output layer. Data is provided from input nodes of the input layer, processing is performed by hidden nodes of the one or more hidden layers, and an output is produced through output nodes of the output layer. Deep learning networks typically include multiple hidden layers. Each layer of the neural network can include feature maps or activation maps that can include artificial neurons (or nodes). A feature map can include a filter, a kernel, or the like. The nodes can include one or more weights used to indicate an importance of the nodes of one or more of the layers. In some cases, a deep learning network can have a series of many hidden layers, with early layers being used to determine simple and low-level characteristics of an input, and later layers building up a hierarchy of more complex and abstract characteristics.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

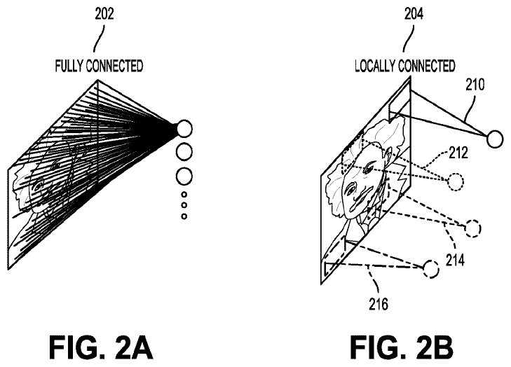

The connections between layers of a neural network may be fully connected or locally connected. FIG. 2A illustrates an example of a fully connected neural network 202. In a fully connected neural network 202, a neuron in a first layer may communicate its output to every neuron in a second layer, so that each neuron in the second layer will receive input from every neuron in the first layer. FIG. 2B illustrates an example of a locally connected neural network 204. In a locally connected neural network 204, a neuron in a first layer may be connected to a limited number of neurons in the second layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer, as the higher layer neurons in a given region may receive inputs that are tuned through training to the properties of a restricted portion of the total input to the network.

As mentioned previously, systems and techniques are described herein for processing images (e.g., image data and/or video data) using temporally-propagated cluster maps. In some examples, the systems and techniques can be used to perform unsupervised semantic segmentation based on using temporally-propagated cluster maps of similar patch representations. By tracking the patch location(s) of one or more patch representations in the local windows of temporally proximate frames (e.g., adjacent frames in time, etc.), different object views can be detected across time. Based on detecting multiple different views of the same object, a machine learning head (e.g., an MLP head) can be trained to generate representations that are the most locally similar (e.g., maximize similarity within the frame) and are also globally similar (e.g., maximize similarity across the entire training set). In some aspects, the systems and techniques can implement self-supervised learning based on Swapping Assignments between multiple Views of the image (SwAV), which may be used on patch representations (e.g., rather than on image representations).

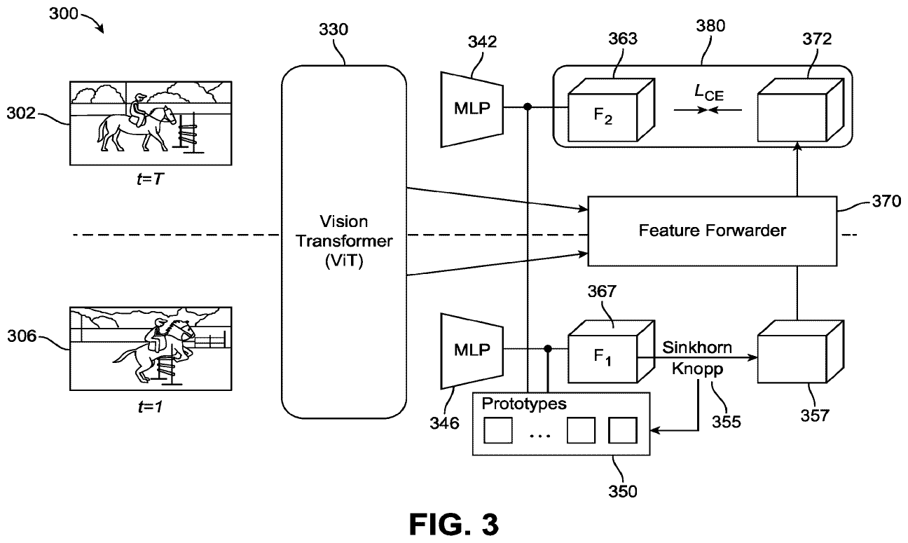

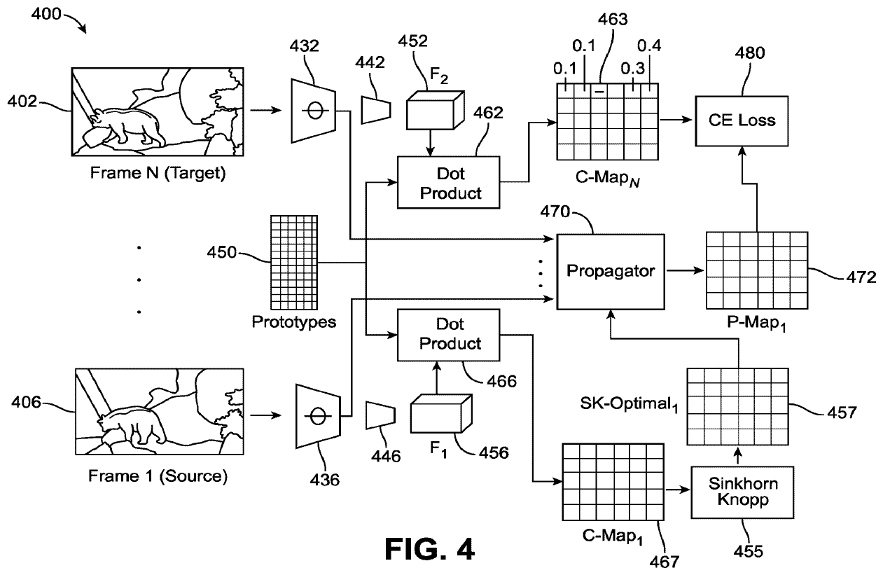

FIG. 3 is a diagram illustrating an example machine learning architecture 300 that can be used by the systems and techniques described herein. For example, the machine learning architecture 300 can be used to process images (e.g., image data and/or video data) using temporally-propagated cluster maps. In some cases, the machine learning architecture 300 can be used to perform self-supervised semantic segmentation based on temporally-propagated cluster maps of similar patch representations, as will be described in greater depth below. FIG. 4 is a diagram illustrating another example machine learning architecture 400 that can be used by the systems and techniques described herein. In some cases, the example machine learning architecture 400 of FIG. 4 can be the same as or similar to the example machine learning architecture 300 of FIG. 3.

In some aspects, the systems and techniques described herein can utilize one or more image representations (e.g., features) generated or otherwise obtained for one or more input images. For example, one or more features and/or sets of features can be generated for the images 302 and 306 using a pre-trained machine learning network 330, as will be described in greater depth below. The image 302 and the image 306 can be included in a plurality of input images. For instance, image 302 can be a frame of image or video data associated with a time t=T and the image 306 can be a frame of image or video data associated with a time t=1.

In some cases, the machine learning architecture 300 can utilize image representations (e.g., features) that are extracted or determined using a pre-trained machine learning network 330. In some aspects, the pre-trained machine learning network 330 can be transformer-based and/or can include one or more transformer-based layers. For example, the pre-trained machine learning network 330 can be implemented using one or more vision transformers (ViTs), and may be referred to as the VIT 330. In some aspects, the pre-trained machine learning network 330 can be provided as a self-Distillation with NO labels (DINO) vision transformer (e.g., a DINO ViT), and may be referred to as the DINO VIT 330.

A vision transformer (ViT) can operate on an input sequence of image data that includes patches of fixed size P×P. For example, for a color image I of spatial size H×W, there are N=H×W/P² image patches of size P² (e.g., it can be assumed for simplicity that H and W are multiples of P). Each image patch can first be embedded in a d-dimensional latent space via a trained linear projection layer. For example, the images 302 and 306 can be provided as input to the VIT 330 and used to generate a plurality of image patches, with each image patch subsequently being embedded in the d-dimensional latent space via a trained linear projection layer included in the VIT 330. An output of embedding an image patch via the trained linear projection layer can be referred to as a patch embedding.

A learned vector referred to as a “class token” (e.g., CLS) is adjoined to the respective patch embeddings. The class token learned vector corresponds to a transformer input in R^{(N+1)d}. In some aspects, the systems and techniques may implement classification that only uses the CLS token(s) adjoined to the respective patch embeddings. In some cases, classification based on the CLS token(s) may additionally utilize all N features of the final layer. For example, the N features can be selected from either query (Q), key (K), or value (V) attention values included in or determined by a last self-attention layer (e.g., last self-attention block) of the VIT 330.

In some aspects, the VIT 330 can determine self-attention using one or more transformer-based layers that receive query (Q), key (K), and value (V) inputs. The Q, K, and V inputs can be obtained from the same embedding sequence and/or the same set of features. Cross-attention can be determined using Q values obtained from a first embedding sequence and using K and V values obtained from a second embedding sequence different than the first embedding sequence. A transformer (e.g., including a vision transformer, such as the VIT 330) may utilize an encoder-decoder architecture. Each encoder and decoder layer can include an attention mechanism. For each portion of an input, attention can be used to weight the relevance of every other portion of the input and generate a corresponding output. Decoder layers can include an additional attention mechanism that utilizes information from decoder output(s) at previous time steps. For example, a decoder layer can include an attention mechanism for processing (e.g., at time t) information from decoder outputs at previous time steps (e.g., t−1, t−2, etc.). The decoder layer attention mechanism for processing information from previous time steps can be upstream of (e.g., used prior to) an additional decoder layer attention mechanism for processing information from the encodings associated with the current time step.

In some aspects, a vision transformer (e.g., such as the VIT 330) can be implemented based on splitting an input image into a plurality of fixed-sized patches and linearly embedding the patches, as described above. Position embeddings can be added to the linearly embedded patches, and the resulting sequence of vectors can be provided as input to a transformer encoder architecture. To perform classification, an additional learnable classification token (e.g., the CLS token described above) can be added to the sequence of vectors that is provided as input to the VIT.

A transformer can determine attention weights simultaneously between all of the tokens included in a given input sequence, such as the input sequence of vectors noted above (e.g., wherein the tokens correspond to the linear embeddings of the image patches plus the CLS token, etc.). For example, an attention layer can generate an embedding for each respective token such that the embedding includes (or is otherwise indicative of) information associated with the respective token and a weighted combination of other relevant tokens associated with the respective token. The other relevant tokens associated with the respective token may each be weighted by a corresponding attention weight (e.g., wherein the attention weight is indicative of the weight or strength of the association between the relevant token and the respective token).

An attention layer can be trained to learn three attention weighting matrices, given as a query weights matrix W_{Q}, a key weights matrix W_{K}, and a value weights matrix W_{V}. For each token i, the corresponding token embedding xᵢ is multiplied by the three attention weighting matrices to produce a query vector qᵢ=xᵢW_{Q}, a key vector kᵢ=xᵢW_{K}, and a value vector vᵢ=xᵢW_{V}. Attention weights can be determined based on the query vector q, and the key vector kᵢ. For example, the attention weight aᵢⱼ from token i to token j can be determined as the dot product between qᵢ and kⱼ. Based on the query weights matrix, W_{Q}, and the key weights matrix, W_{K}, being provided as two separate matrices, attention can be non-symmetric. For example, the attention weight aᵢⱼ can be determined as the dot product qᵢ‰kⱼ and represents the attention from token i to token j. When attention is non-symmetric, the attention weight di can be different than the attention weight aⱼᵢ (e.g., the attention weight from token j to token i), which can be determined as the dot product qᵢ·kᵢ. The output of a transformer attention layer for a given token i is the weighted sum of the value vectors (e.g., vᵢ) of all tokens, weighted by aᵢⱼ, the attention from token i to each of the j additional tokens. For example, an attention layer can determine attention values by computing a matrix of outputs as:

$$Attention ( Q , K , V ) = softmax ( \frac{Q {K}^{T}}{\sqrt{{d}_{k}}} ) V$$

Here, the matrix Q is the matrix including all of the i query vectors qᵢ as row entries; the matrix K is the matrix including all of the i key vectors k, as row entries; and the matrix V is the matrix including all of the i value vectors v, as row entries. For example, Q=W_{q}·X; K=Wₖ·X; and V=Wᵥ·X. In some aspects, when the inputs to Q, K, V are the same X, the attention computation is a “self” attention. When the inputs to Q. K. V are not the same X, the attention computation is a “cross” attention. For example, self-attention can be determined by using the same embedding sequence X as input to Q. K, and V. Cross-attention can be determined by using a first embedding sequence X₁ as input to Q and a second embedding sequence X₂ as input to K and V. The W_{q}, Wₖ, and Wᵥ terms are linear layers that project or map the input vector X to the query (Q), key (K), and value (V) matrices. The term dₖ refers to a dimension of a key k, with \sqrt{dₖ} acting as a scaling factor. Softmax refers to a Softmax function that is used obtain weights on the self-attention values. The layer norm can output the weights to the feedforward neural network component described previously above, as being provided prior to or at the output of the transformer encoder layers and the output of the transformer decoder layers.

In some aspects, the systems and techniques can use a Sinkhorn-Knopp assignment algorithm to determine an optimal assignment between spatial patches (e.g., image patches) and a set of prototypes. In some examples, the Sinkhorn-Knopp engine 355 of FIG. 3 can be the same as or similar to the Sinkhorn-Knopp engine 455 of FIG. 4. The Sinkhorn-Knopp assignment algorithm can be implemented by the Sinkhorn-Knopp engine 355 and/or the Sinkhorn-Knopp engine 455. The Sinkhorn-Knopp assignment algorithm can be used to solve an optimal assignment problem using an iterative approximation.

For example, the systems and techniques can generate the modified cluster map 357 of FIG. 3 based on using the Sinkhorn-Knopp engine 355 to determine the optimal assignment between spatial image patches and the set of prototypes 350. In some aspects, the modified cluster map 357 can be generated using the optimal assignment information determined by the Sinkhorn-Knopp engine 355. In some examples, the systems and techniques can generate the modified cluster map 457 of FIG. 4 based on using the Sinkhorn-Knopp engine 455 to determine the optimal assignment between spatial image patches and the set of prototypes 450. In some cases, the modified cluster map 457 can be generated using the optimal assignment information determined by the Sinkhorn-Knopp engine 455. In some cases, the modified cluster map 357 and/or the modifier cluster map 457 may be referred to as an “optimal cluster map” or collectively may be referred to as “optimal cluster maps.”

In some examples, the Sinkhorn-Knopp engine 355 and/or 455 can utilize cosine similarity as the similarity measure for determining the optimal assignment between spatial image patches and the set of prototypes 350 or 450, respectively. The Sinkhom-Knopp engine 355 and/or 455 can utilize a pre-determined or configured number of iterations (e.g., three iterations, or various other suitable iteration quantities, etc.). In some aspects, based on using the Sinkhorn-Knopp engine (e.g., 355, 455), the systems and techniques can keep the entropy of assignment between the image patches and the prototypes to a given minimum threshold, which can avoid trivial solutions and/or mode collapse.

In some illustrative examples, the Sinkhorn-Knopp engine 355 of FIG. 3 can be used to determine an optimal assignment between spatial image patches generated using the VIT 330 and a set of prototypes 350. In some cases, the VIT 330 can generate the spatial image patches based on the input images 302 and/or 306. In some aspects, the spatial patches provided as input to the Sinkhorn-Knopp engine 355 can be generated and output by one or more machine learning heads, such as by one or more of the multi-layer perceptron (MLP) heads 342, 346.

In another example, the Sinkhorn-Knopp engine 455 of FIG. 4 can be used to determine an optimal assignment between a set of prototypes 450 and spatial patches generated using the image encoders 432, 436 and/or using the MLPs 442, 446. For instance, the spatial patches can be spatial image patches corresponding to one or more frames of image data, including the source frame 406 and/or the target frame 402 of FIG. 4. In some cases, the image encoders 432 and 436 can be the same as or similar to one another. In some examples, the image encoders 432 and 436 may be provided as separate image encoders or may be provided as a single, combined image encoder. In some examples, the image encoders 432 and 436 can be implemented as ViTs and/or DINO ViTs. For instance, image encoder 432 can be implemented using a first ViT and image encoder 436 can be implemented using a second ViT. In some aspects, the image encoders 432 and/or 436 can be the same as or similar to the VIT 330 of FIG. 3.

The MLPs 442 and 446 of FIG. 4 may additionally be the same as or similar to one another and may be provided as separate MLPs. In some examples, one or more (or both) of the MLPs 442 and 446 of FIG. 4 can be the same as or similar to the MLP heads 342, 346, respectively, of FIG. 3. In some cases, the prototypes 450 of FIG. 4 can be the same as or similar to the prototypes 350 of FIG. 3.

In some aspects, given a source image I₁ and a target image I₂ as two arbitrary training samples, the systems and techniques can extract feature maps F₁ and

$${F}_{2} ∈ {R}^{D \times \frac{H}{P} \times \frac{W}{P}} ,$$

respectively, from the source image I₁ and a target image I₂. In some aspects, the pre-trained ViT model (e.g., the VIT 330 of FIG. 3 and/or the ViTs 432, 436 of FIG. 4) can be used to extract the feature maps from the source image I₁ and a target image I₂.

For example, with reference to FIG. 3, the source image I₁ can be the input image 306 (e.g., also referred to as the source image 306) and the target image I₂ can be the input image 302 (e.g., also referred to as the target image 302). The feature map F₁ (shown as the feature map 367 in FIG. 3) can be extracted from the source image 306 using the VIT 330. In some cases, the feature map F₁ can also be referred to as the source feature map 367, and corresponds to the source image 306. The feature map F₂ (shown as the feature map 363 in FIG. 3) can be extracted from the target image 302 using the VIT 330. In some cases, the feature map F₂ can also be referred to as the target feature map 363, and corresponds to the target image 302.

With reference to FIG. 4, the source image I₁ can be the input image 406 (e.g., also referred to as the source image 406) and the target image I₂ can be the input image 402 (e.g., also referred to as the target image 402). The feature map F₁ can be the same as the F₁ feature map 456, and may be extracted from (e.g., generated based on) the source image 406 using the ViT 436. The feature map F₂ can be the same as the F₂ feature map 452, and may be extracted from (e.g., generated based on) the target image 402 using the VIT 432.

If a given relationship exists between specific regions of the source image I₁ and the target image I₂, then the same given relationship should also hold for the features that are extracted from those specific regions of the source and target images. In some aspects, the source image I₁ can be the same as or similar to the source image 306 of FIG. 3, the source image 406 of FIG. 4, etc. The target image I₂ can be the same as or similar to the target image 302 of FIG. 3, the target image 402 of FIG. 4, etc.

In some aspects, the source image I₁ and the target image I₂ can represent different views of the same scene or object(s). For example, the source and target images can represent different temporal views of a same scene, a same environment, a same set of objects, etc. In some cases, the source and target image pairs (306 and 302, respectively, in FIGS. 3:406 and 402, respectively, in FIG. 4) can be obtained using the same camera. In some aspects, the source-target image pairs (306, 302) and/or (406, 402) can be temporally proximate pairs of images (e.g., such as a pair of frames included in the same video data, etc.). For example, the source image 306, 406 may depict a scene at a first time t₁ and the target image 302, 402 may depict the same scene at a second time 12 that is different from the first time t₁.

In some aspects, the target image I₂ (e.g., 302, 402) can be represented as a function of the source image I₁ (e.g., 306, 406). For example, the relationship between the source and target images can be given as I₂=A(I₁)). As noted previously, a relationship between regions of the source and target images will also exist between the respective source and target features extracted from the same image regions. For example, the same relationship between source and target images I₁ and I₂ should also exist between the source and target feature maps F₁ and F₂. Based on the relationship existing between the source and target feature maps, the intersection of different views of an image scene can correspond to the same patch or feature representation. The intersection of different views of an image scene can be an intersection between the respective views of source and target images 306, 302 of FIG. 3, an intersection between the respective views of source and target images 406, 402 of FIG. 4, etc.

For example, the same features or patch representation should be present in F₁ and F₂ to represent the intersecting portion of the corresponding source and target images I₁ and I₂. The commonality of the features or patch representation can be based on the intersecting portion of the source and target images I₁ and I₂, respectively, depicting the same scene or visual content but from slightly different views (e.g., slightly different points in time and/or space).

As noted above, the Sinkhorn-Knopp engine 355 of FIG. 3 and/or the Sinkhorn-Knopp engine 455 of FIG. 4 can be used to implement the Sinkhorn-Knopp assignment algorithm to solve an optimal assignment problem (e.g., to determine an optimal assignment) using an iterative approximation. For example, the use of the Sinkhorn-Knopp engine 355, 455 can prevent the feature patch representations from collapsing or becoming stuck in the same values for all different inputs (e.g., all different input pairs of a source image 306, 406 and a target image 302, 402). In some cases, the Sinkhorn-Knopp engine 355, 455 can be used to generate learned features that are more generalizable for downstream semantic segmentation tasks. In some examples, instead of using augmentations to generate different views of an input image, the systems and techniques can utilize one or more natural augmentations (e.g., one or more natural view differences) existing in an unlabeled video and/or video input.

For example, given an input video or video data (e.g., a sequence of image and/or video frames), the exact relationship between frames may not be known. For example, it may not be known if an object depicted in the video has moved or has not moved, a-priori. Additionally, as the systems and techniques are used to perform spatially-dense training, the mapping of one patch in the source feature map F₁ to another (e.g., corresponding) patch in the target feature map F₂ may also be unknown. In some cases, the systems and techniques can perform patch mapping between the source feature map F₁ and the target feature map F₂ (e.g., the feature maps 367 and 363, respectively, in FIG. 3: the feature maps 456 and 452, respectively, in FIG. 4) using a Temporal Patch Propagator (TPP).

For instance, the feature forwarder 370 of FIG. 3 can be a TPP used to perform patch mapping between the source feature map F₁ and the target feature map F₂. In some examples, the propagator 470 of FIG. 4 can be a TPP used to perform patch mapping between the source feature map F₁ and the target feature map F₂. In some aspects, the TPP (e.g., the feature forwarder 370 of FIG. 3 and/or the propagator 470 of FIG. 4) can be used to determine a correspondence of patches between two frames, such as a correspondence of patches between the source frame I₁ and the target frame I₂ (e.g., between the source image 306 and the target image 302 of FIG. 3: between the source image 406 and the target image 40 of FIG. 4: etc.). In some examples, the TPP (e.g., the feature forwarder 370 of FIG. 3 and/or the propagator 470 of FIG. 4) can determine the correspondence of patches between two frames according to the following (e.g., see Algorithm 1 below for an illustrative example implementation of a temporal patch propagator (TPP)).

In some aspects, the TPP (e.g., the feature forwarder 370 and/or the propagator 470) can utilize a neighborhood assumption. For example, given two temporally close (e.g., temporally proximate) frames I₁ and I₂, each given patch included in the source frame I₁ must be located in the target frame I₂ within a local window around the patch position from the source frame I₁ (e.g., between I₁ and I₂, each given patch included in I₁ can only move to a position within a local window in I₂). The neighborhood assumption and utilization of local windows for patch movement between I₁ and I₂ can be based on the fact that temporally proximate video frames are changing smoothly across time, as noted previously.

The TPP (e.g., the feature forwarder 370 of FIG. 3 and/or the propagator 470 of FIG. 4) can additionally utilize semantic similarities to indicate (e.g., determine) movement between frames. For example, if the respective feature maps F₁ and F₂ are of a same or similar quality (e.g., size, resolution, accuracy, etc.), then two patches p_{(1,i)}∈F₁ and p_{(2,j)}∈F₂ included in a local window (e.g., based on the neighborhood assumption described above) are likely to represent the same semantic content if their similarity exceeds a certain threshold. For example, in some aspects, similarities from the feature maps F₁ and F₂ can be used to compute a function that maps every patch from I₁ to patches in I₂.

In some aspects, the systems and techniques can utilize a pre-trained self-supervised backbone (e.g., the pre-trained machine learning network 330 of FIG. 3, which can be implemented as a ViT, DINO ViT, etc.: the ViTs 432, 436 of FIG. 4; etc.) to extract the feature maps F₁ and F₂. To find the equivalent of the source image patch p_{(1,i)} in the target image feature map F₂, the systems and techniques can use a local window in F₂ that is centered around the location of p_{(1,i)} in F₁. For instance, the local window in F₂ can be used to determine which patch location(s) in F₂ are consistent with the neighborhood assumption and the semantic similarity assumption (e.g., similarity threshold) described above.

In some aspects, based on determining the matching patches between I₁ and I₂, the systems and techniques can then ensure that the representations are generated to be similar to one another. Forcing similar representations can provide a training signal (e.g., for self-supervised training) that is utilized by the systems and techniques described herein. In some aspects, while the representation of equal (e.g., matching) patches may be similar in a local window between F₁ and F₂, the representation(s) of the patches might not be similar globally. In some examples, the systems and techniques can use a self-supervised clustering approach on the patch representations of frames (e.g., instead of the image-level representations) to generate a cluster map for each image.

For example, as shown in FIG. 4, a target cluster map 463 (e.g., denoted as C-Map_{N}) can be generated for the target image 402 (e.g., I_{N}). A source cluster map 467 (e.g., denoted as C-Map₁) can be generated for the source image 406 (e.g., I₁). In some examples, the cluster maps can be generated based on the set of prototypes 450 and based on the source and the target feature maps 456, 452, respectively. For example, the target cluster map 463 can be generated as the dot product between the prototypes 450 and the source F₁ feature map 456 (e.g., using the dot product engine 466). The source cluster map 467 can be generated as the dot product between the prototypes 450 and the F₂ feature map 452 (e.g., using the dot product engine 462).

In some cases, a cluster map (e.g., such as the target cluster map 463, the source cluster map 467, etc.) can be indicative of one or more probability values associated with each location (e.g., of a plurality of locations) included in or otherwise represented by the cluster map. For example, as noted previously, a cluster map can be generated as a dot product between the prototypes 450 and a respective one of the feature maps (e.g., F₁, F₂, . . . , F_{N}). The cluster map can have dimensions that are the same as the feature map and/or the prototypes 450 (e.g., based on generating the cluster map as an inner dot product between a feature map and prototypes). In some aspects, each location included in the cluster map may be associated with an image patch location in the respective feature map F₁, F₂, etc. (e.g., may be associated with the features generated for a given image patch and image patch location within the source image 406 or the target image 402, respectively). As noted above, each location of a plurality of locations included in a cluster map can include or otherwise be associated with a respective probability value. In some aspects, the respective probability value associated with a given location in the cluster map can be indicative of a probability that at least one prototype (e.g., included in the prototypes 450) is present at the given location in the cluster map. In some cases, the respective probability can be a probability that any prototype included in the set of prototypes 450 is present at the given location in the cluster map. In some examples, the respective probability can be a probability that a corresponding prototype included in the set of prototypes 450 is present at the given location in the cluster map. In some examples, the respective probabilities associated with each location included in the cluster map can be included in or determined using a probability distribution (e.g., the respective probabilities associated with the plurality of locations in the cluster map can sum to a value of 1 (e.g., a probability of 100%)).

The source cluster map 467 (e.g., C-Map₁) associated with the source image 406 (e.g., I₁) can be provided as input to the Sinkhorn-Knopp engine 455, which can generate or determine an optimal assignment based on the source cluster map 467. The optimal assignment based on the source cluster map 467 can be used to generate the modified cluster map 457 (e.g., denoted in FIG. 4 as the modified cluster map “SK-Optimal₁”). In some aspects, the modified cluster map 457 can be provided as input to the propagator 470. The propagator 470 can be a TPP which utilizes the modified cluster map 457, the source F₁ feature map 456, and the target F₂ feature map 452 to determine and generate as output a propagated cluster map 472 (e.g., denoted as the propagated cluster map “P-Map₁” in FIG. 4).

In some cases, the modified cluster map 457 (e.g., the cluster map SK-Optimal₁) can be propagated by the propagator 470 (e.g., which can be a TPP and/or can be the same as or similar to the feature forwarder 370 of FIG. 3) to the last frame of the input image or video sequence (e.g., the target image IN). Based on the propagation, the modified cluster map 457 can be compared with the cluster map generated for the last frame (e.g., the cluster map C-Map_{N} 463 of FIG. 4 and/or the cluster map 372 of FIG. 3). In some examples, the comparison can be based on using a cross-entropy objective function (e.g., the cross entropy (CE) loss function [symbol] _{CE} 380 of FIG. 3 and/or the CE loss function 480 of FIG. 4) as follows:

$$C - {Map}_{T} ( i , j ) = < {F}_{T} ( i ) , {Pr}_{j} > , ∀ i ∈ N \qquad Eq . ( 1 )$$

$$C - {Map}_{T} ( i , j ) = \frac{{e}^{C - {Map}_{T} ( i , j ) / τ}}{{\sum }_{j} {e}^{C - {Map}_{T} ( i , j ) / τ}} \qquad Eq . ( 2 )$$

$$Loss = {\sum }_{i , j} P - {Map}_{1} ( i , j ) log ( C - {Map}_{T} ( i , j ) ) \qquad Eq . ( 3 )$$

Here, Eq. (1) can be used to compute the similarity of each patch representation F_{T}(i) with each of the prototypes Prⱼ. Eq. (2) can be used to normalize the cluster maps C-Map_{T}(i,j) with a softmax normalization, where t is a temperature parameter of the softmax. Eq. (3) is a CE loss function (e.g., associated with the cross entropy (CE) loss function [symbol] _{CE} 380 of FIG. 3 and/or the CE loss function 480 of FIG. 4). In some examples, Eqs. (1) and (2) can be used to force the patch representations of different frames to not only be locally consistent, but to also be globally consistent.

In the example Algorithm 1 below, provided is an illustrative example of a pseudo-code implementation of a Temporal Patch Propagator (TPP) (e.g., such as the feature forwarder 370 of FIG. 3 and/or the propagator 470 of FIG. 4):

Algorithm 1 Pseudo-code implementation of
an Example Temporal Patch Propagator (TPP)

| | |
|---|---|
| 1: | previous-features = [ ] (nmb-context, dim, h*w) |
| 2: | previous-maps = [ ] |
| 3: | for i = 1, 2, ... , N − 1 do |
| 4: | previous-features.append(F[i]) |
| 5: | previous-maps.append(C-Map[i) |
| 6: | end for |
| 7: | feature-source = Stack(previous-features) |
| 8: | feature-target = F[N] (1, dim, h*w) |
| 9: | feature-target = Normalize(feature-target, dim=1, p=2) |
| 10: | feature-source = Normalize(feature-source, dim=1, p=2) |
| 11: | aff = exp(bmm(feat-tar, feat-source) / 0.1) |
| 12: | aff = Change-Shape(aff, (nmb-context * h*w (sources), h*w (target))) |
| 13: | aff = aff / torch.sum(aff, keepdim=True, axis=0) |
| 14: | aff = mask-neighborhood(aff) |
| 15: | previous-maps = Stack(previous-maps) (nmb-context, C, h, w) |
| 16: | previous-maps = Change-Shape(previous-maps, (C, nmb-context*h*w)) |
| 17: | target-cmap = torch.mm(previous-maps, aff) |

Described below are three evaluation protocols for the video domain (e.g., specific to video domain requisites), which can be used to benchmark unsupervised semantic video object segmentation. In some aspects, a trained object segmentation model (e.g., such as the example machine learning architecture 300 of FIG. 3, the example machine learning architecture 400 of FIG. 4, etc.) can be evaluated based on assigning different objects in a frame to different identifiers (IDs).

In another example, a trained object segmentation model can be evaluated based on forcing the class IDs assigned to different objects to be consistent over time (e.g., which may be an inherent characteristic of videos, as video frames are not independent of one another). In another example, a trained object segmentation model can be evaluated based on forcing the assigned IDs to be globally different yet consistent across a given training dataset. In some aspects, the third evaluation protocol can be implemented as an enhanced combination of the first and second evaluation protocols. In some cases, the first, second, and third protocols/approaches may also be referred to as frame-wise, clip-wise, and dataset-wise evaluation metrics, respectively.

In some aspects, the systems and techniques can assign class IDs based on applying K-Means on the representation of the given pre-trained model to produce a cluster map for each input data. The cluster maps can be matched to the test-time ground truth and a mean intersection-over-union (MIOU) corresponding to the matching between cluster maps and corresponding test-time ground truth can be reported. For example, MIOU can be determined as an average (or mean) between the IoU of the segmented objects over all the video frames of a test dataset. Therefore, given an input data with the size [batch-size, clip-size, c, h, w], the Model M, a matching algorithm MA, and clustering algorithm C, the example pseudo-code implementation described below in Algorithm 2 provides an illustrative example of an implementation of the above-noted evaluation protocols:

Algorithm 2 Pseudo-code implementation
of an Example Evaluation Pipeline

| | |
|---|---|
| 1: | input = input.reshape(bs * cs, c, h, w) |
| 2: | F_{b} = M(input) |
| 3: | F_{b} = F.reshape(bs, cs, num-patch, dim) |
| 4: | score-list = [ ] |
| 5: | if frame-wise then |
| 6: | for F_{c} In F_{b} do |
| 7: | for F_{f} In F_{c} do |
| 8: | C-Map = C(F_{f}) |
| 9: | score = MA(C-Map, GT_{f}) |
| 10: | score-list.append(score) |
| 11: | end for |
| 12: | end for |
| 13: | else if clip-wise then |
| 14: | for F_{c} In Fₐₗₗ do |
| 15: | C-Maps = C(F_{c}) |
| 16: | score = MA(C-Maps, GT_{c}) |
| 17: | score-list.append(score) |
| 18: | end for |
| 19: | else if dataset-wise then |
| 20: | C-Maps = C(F_{b}) |
| 21: | score = MA(C-Maps, GT_{b}) |
| 22: | score-list.append(score) |
| 23: | end if |
| 24: | print(score-list.mean( )) |

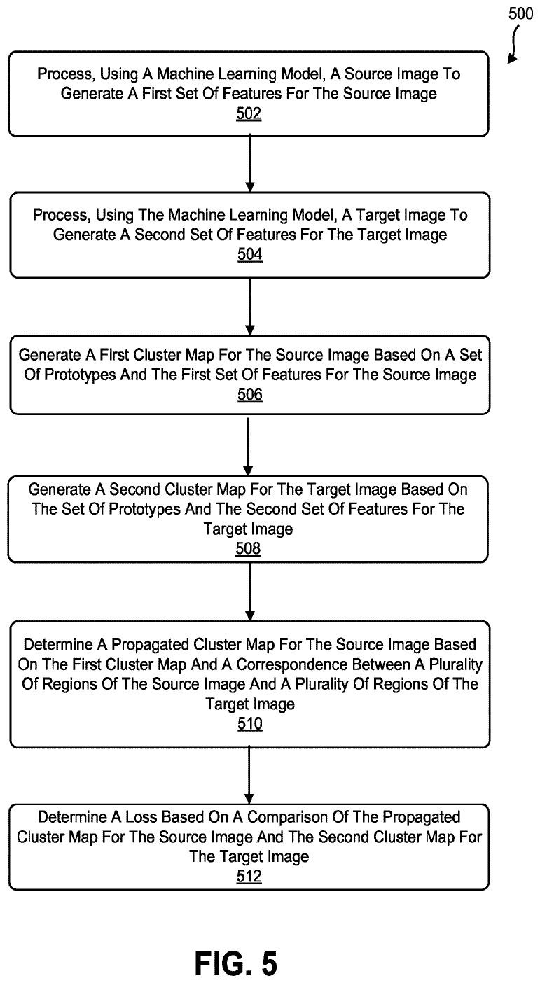

FIG. 5 is a flowchart illustrating an example of a process 500 for processing image and/or video data. Although the example process 500 depicts a particular sequence of operations, the sequence may be altered without departing from the scope of the present disclosure. For example, some of the operations depicted may be performed in parallel or in a different sequence that does not materially affect the function of the process 500. In other examples, different components of an example device or system that implements the process 500 may perform functions at substantially the same time or in a specific sequence.

At block 502, the process 500 includes processing, using a machine learning model, a source image to generate a first set of features for the source image. For example, the machine learning model can be a dense self-supervised machine learning model. In some cases, the machine learning model can be a vision transformer (ViT) and/or can include one or more ViT layers. In some examples, the machine learning model can be the same as or similar to a self-Distillation with NO labels (DINO) vision transformer (e.g., a DINO VIT). For example, the machine learning model can be the same as or similar to the DINO VIT 330 of FIG. 3. In some cases, the machine learning model can be a pre-trained machine learning model. In another example, the machine learning model can be the same as or similar to one or more (or both) of the VIT 432 and/or the VIT 436 of FIG. 4.

The source image can be an image frame that is included in a video or video data. For example, the source image can be the same as or similar to the source image frame 306 of FIG. 3 and/or the source image frame 406 of FIG. 4. In some cases, the source image can be associated with a first time (e.g., t=1) or timestamp included in a video data.

The first set of features can be generated as a feature map. For example, the first set of features can be the same as or similar to the first set of features 456 of FIG. 4. In some cases, the first set of features can also be referred to as an F₁ feature map and/or a source image F₁ feature map.

At block 504, the process 500 includes processing, using the machine learning model, a target image to generate a second set of features for the target image. The target image can be associated with the source image of block 502 and/or can be included in the same video or video data as the source image of block 502. For example, the source image can be associated with a first time t=1 and the target image can be associated with a second time t=N, wherein the second time is later than (e.g., after) the first time. In some aspects, the target image can be the same as or similar to the target image 302 of FIG. 3 and/or the target image 402 of FIG. 4.

The second set of features can be generated as a feature map. For example, the second set of features can be the same as or similar to the second set of features 452 of FIG. 4. In some cases, the second set of features can also be referred to as an F₂ feature map and/or a target image I₂ feature map.

At block 506, the process 500 includes generating a first cluster map for the source image based on a set of prototypes and the first set of features for the source image. For example, the first cluster map can be the same as or similar to the first cluster map 367 of FIG. 3 and/or the first cluster map 467 of FIG. 4 (e.g., denoted as the cluster map C-Map₁). In some examples, the set of prototypes can be the same as or similar to the set of prototypes 350 of FIG. 3 and/or the set of prototypes 450 of FIG. 4. In some cases, generating the first cluster map for the source image comprises determining a dot product of the set of prototypes and the first set of features. For example, the first cluster map 467 of FIG. 4 can be determined as the dot product of the set of prototypes 450 and the first set of features 456, using a dot product engine 466.

In some examples, each location of a plurality of locations of the first cluster map is associated with a respective region of the plurality of regions of the source image. In some cases, each location of the plurality of locations of the first cluster map includes a respective probability value, wherein a probability value for a particular location of the plurality of locations of the first cluster map indicates a probability that a respective prototype from the set of prototypes is present in the particular location.

At block 508, the process 500 includes generating a second cluster map for the target image based on the set of prototypes and the second set of features for the target image. For example, the second cluster map can be the same as or similar to the second cluster map 363 of FIG. 3 and/or the second cluster map 463 of FIG. 4 (e.g., denoted as the cluster map C-Map_{N}). In some examples, the set of prototypes can be the same as or similar to the set of prototypes 350 of FIG. 3 and/or the set of prototypes 450 of FIG. 4. In some cases, generating the second cluster map for the target image comprises determining a dot product of the set of prototypes and the second set of features. For example, the second cluster map 463 of FIG. 4 can be determined as the dot product of the set of prototypes 450 and the second set of features 452, using a dot product engine 462. In some examples, the same dot product engine can be used to generate the second set of features for the target image and to generate the first set of features for the source image.

In some examples, each location of a plurality of locations of the second cluster map is associated with a respective region of the plurality of regions of the target image. In some cases, each location of the plurality of locations of the second cluster map includes a respective probability value, wherein a probability value for a particular location of the plurality of locations of the second cluster map indicates a probability that a respective prototype from the set of prototypes is present in the particular location.

At block 510, the process 500 includes determining a propagated cluster map for the source image based on the first cluster map and a correspondence between a plurality of regions of the source image and a plurality of regions of the target image. For example, the propagated cluster map can be the same as or similar to the propagated cluster map 372 of FIG. 3 and/or the propagated cluster map 472 of FIG. 4. In some examples, the propagated cluster map can be determined using a propagator. For example, patch mapping between the first set of features and the second set of features can be performed using a Temporal Patch Propagator (TPP) (e.g., such as the feature forwarder 370 of FIG. 3 and/or the propagator 470 of FIG. 4) In some cases, the propagated cluster map can be indicative of a correspondence of patches between the source image and the target image. In some examples, the propagator can be implemented based on the illustrative example implementation of Algorithm 1, provided above.

In some examples, an assignment algorithm can be used to determine an assignment between the set of prototypes and the first set of features for the source image. For example, the assignment algorithm can be a Sinkhorn-Knopp assignment algorithm, which may be the same as or similar to the Sinkhorn-Knopp assignment algorithm implemented by the Sinkhorn-Knopp engine 355 of FIG. 3 and/or the Sinkhorn-Knopp engine of FIG. 4.

In some cases, the determined assignment can be used to generate a modified cluster map for the source image. For example, the determined assignment from the Sinkhorn-Knopp engine 455 can be used to generate the modified cluster map 457 (e.g., denoted as the cluster map “SK-optimal₁”) of FIG. 4. In another example, the determined assignment from the Sinkhorn-Knopp engine 355 can be used to generate the modified cluster map 357 of FIG. 3. The modified cluster map for the source image can be generated based on an optimal assignment determined using the Sinkhorn-Knopp assignment algorithm.

In some examples, determining the correspondence between the plurality of regions of the source image and the plurality of regions of the target image comprises determining a subset of features from the second set of features that matches a subset of features from the first set of features, within a matching threshold. For example, the subset of features from the second set of features can be within a local window around a location in the second set of features relative to a corresponding location in the second set of features.

At block 512, the process 500 includes determining a loss based on a comparison of the propagated cluster map for the source image and the second cluster map for the target image. For example, the loss can be determined as a cross entropy (CE) loss. In some examples, the loss can be determined using the cross entropy (CE) loss function [symbol] _{CE} 380 of FIG. 3 and/or using the CE loss function 480 of FIG. 4. For example, the CE loss function [symbol] _{CE} 380 of FIG. 3 can be used to determine a cross entropy loss based on a comparison of the propagated cluster map 372 generated by the feature forwarder 370 (e.g., TPP, propagator, etc.) and the second cluster map 363 generated based on the target image 302. In another example, the CE loss function 480 of FIG. 4 can be used to determine a cross entropy loss based on a comparison of the propagated cluster map 472 (e.g., generated by the propagator 470) and the second cluster map 463 (e.g., generated based on the target image 402). In some examples, the process 500 includes training at least a portion of the machine learning model based on the loss. For example, the training can be self-supervised and/or unsupervised training to perform semantic segmentation of video data and/or to perform semantic segmentation in the video domain.

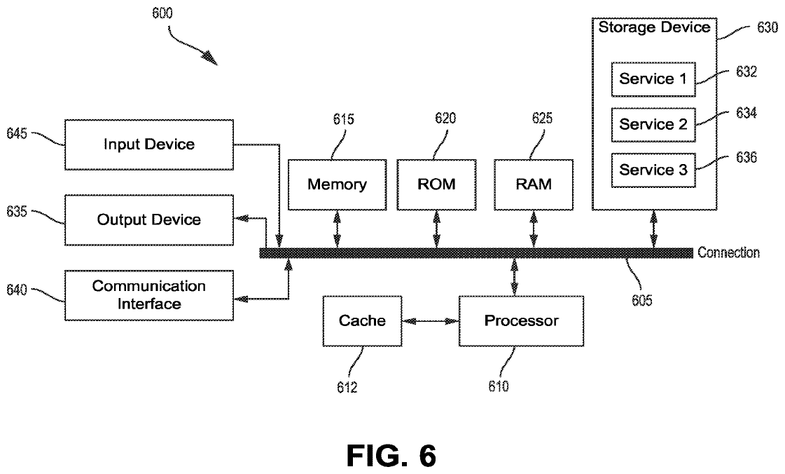

In some examples, the processes described herein (e.g., process 500 and/or any other process described herein) may be performed by a computing device, apparatus, or system. In one example, the process 500 can be performed by a computing device or system having the computing device architecture 600 of FIG. 6. The computing device, apparatus, or system can include any suitable device, such as a mobile device (e.g., a mobile phone), a desktop computing device, a tablet computing device, a wearable device (e.g., a VR headset, an AR headset, AR glasses, a network-connected watch or smartwatch, or other wearable device), a server computer, an autonomous vehicle or computing device of an autonomous vehicle, a robotic device, a laptop computer, a smart television, a camera, and/or any other computing device with the resource capabilities to perform the processes described herein, including the process 500 and/or any other process described herein. In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, a network interface configured to communicate and/or receive the data, any combination thereof, and/or other component(s). The network interface may be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

The process 500 is illustrated as a logical flow diagram, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 500 and/or any other process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 6 illustrates an example computing device architecture 600 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing device architecture 600 can implement the system of FIG. 6. The components of computing device architecture 600 are shown in electrical communication with each other using connection 605, such as a bus. The example computing device architecture 600 includes a processing unit (CPU or processor) 610 and computing device connection 605 that couples various computing device components including computing device memory 615, such as read only memory (ROM) 620 and random-access memory (RAM) 625, to processor 610.

Computing device architecture 600 can include a cache of high-speed memory connected directly with, in close proximity to, or integrated as part of processor 610. Computing device architecture 600 can copy data from memory 615 and/or the storage device 630 to cache 612 for quick access by processor 610. In this way, the cache can provide a performance boost that avoids processor 610 delays while waiting for data. These and other engines can control or be configured to control processor 610 to perform various actions. Other computing device memory 615 may be available for use as well. Memory 615 can include multiple different types of memory with different performance characteristics. Processor 610 can include any general-purpose processor and a hardware or software service, such as service 1 632, service 2 634, and service 3 636 stored in storage device 630, configured to control processor 610 as well as a special-purpose processor where software instructions are incorporated into the processor design. Processor 610 may be a self-contained system, containing multiple cores or processors, a bus, memory controller, cache, etc. A multi-core processor may be symmetric or asymmetric.

To enable user interaction with the computing device architecture 600, input device 645 can represent any number of input mechanisms, such as a microphone for speech, a touch-sensitive screen for gesture or graphical input, keyboard, mouse, motion input, speech and so forth. Output device 635 can also be one or more of a number of output mechanisms known to those of skill in the art, such as a display, projector, television, speaker device, etc. In some instances, multimodal computing devices can enable a user to provide multiple types of input to communicate with computing device architecture 600. Communication interface 640 can generally govern and manage the user input and computing device output. There is no restriction on operating on any particular hardware arrangement and therefore the basic features here may easily be substituted for improved hardware or firmware arrangements as they are developed.

Storage device 630 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 625, read only memory (ROM) 620, and hybrids thereof. Storage device 630 can include services 632, 634, 636 for controlling processor 610. Other hardware or software modules or engines are contemplated. Storage device 630 can be connected to the computing device connection 605. In one aspect, a hardware module that performs a particular function can include the software component stored in a computer-readable medium in connection with the necessary hardware components, such as processor 610, connection 605, output device 635, and so forth, to carry out the function.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific embodiments. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the embodiments and examples provided herein. However, it will be understood by one of ordinary skill in the art that the embodiments may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual embodiments may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as flash memory, memory or memory devices, magnetic or optical disks, flash memory, USB devices provided with non-volatile memory, networked storage devices, compact disk (CD) or digital versatile disk (DVD), any suitable combination thereof, among others. A computer-readable medium may have stored thereon code and/or machine-executable instructions that may represent a procedure, a function, a subprogram, a program, a routine, a subroutine, a module, an engine, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A. B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Claim language or other language reciting “one or more processors configured to,” “one or more processors being configured to,” or the like indicates that one processor or multiple processors (in any combination) can perform the associated operation(s). For example, claim language reciting “one or more processors configured to: X. Y, and Z” means a single processor can be used to perform operations X, Y, and Z: or that multiple processors are each tasked with a certain subset of operations X. Y, and Z such that together the multiple processors perform X, Y, and Z: or that a group of multiple processors work together to perform operations X, Y, and Z. In another example, claim language reciting “one or more processors configured to: X, Y, and Z” can mean that any single processor may only perform at least a subset of operations X, Y, and Z.

The various illustrative logical blocks, modules, engines, circuits, and algorithm steps described in connection with the embodiments disclosed herein may be implemented as electronic hardware, computer software, firmware, or combinations thereof. To clearly illustrate this interchangeability of hardware and software, various illustrative components, blocks, modules, engines, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:
Aspect 1. An apparatus to process image data, the apparatus comprising: one or more memories configured to store the image data; and one or more processors coupled to the one or more memories and configured to: process, using a machine learning model, a source image of the image data to generate a first set of features for the source image; process, using the machine learning model, a target image to generate a second set of features for the target image; generate a first cluster map for the source image based on a set of prototypes and the first set of features for the source image: generate a second cluster map for the target image based on the set of prototypes and the second set of features for the target image; determine a propagated cluster map for the source image based on the first cluster map and a correspondence between a plurality of regions of the source image and a plurality of regions of the target image; and determine a loss based on a comparison of the propagated cluster map for the source image and the second cluster map for the target image.
Aspect 2. The apparatus of Aspect 1, wherein the one or more processors are configured to: train at least a portion of the machine learning model based on the loss.
Aspect 3. The apparatus of any one of Aspects 1 or 2, wherein the machine learning model is a dense self-supervised machine learning model.
Aspect 4. The apparatus of any one of Aspects 1 to 3, wherein, to generate the first cluster map for the source image, the one or more processors are configured to: determine a dot product of the set of prototypes and the first set of features.
Aspect 5. The apparatus of any one of Aspects 1 to 4, wherein, to generate the second cluster map for the target image, the one or more processors are configured to: determine a dot product of the set of prototypes and the second set of features.
Aspect 6. The apparatus of any one of Aspects 1 to 5, wherein each location of a plurality of locations of the first cluster map includes a respective probability value, and wherein a probability value for a particular location of the plurality of locations of the first cluster map indicates a probability that a respective prototype from the set of prototypes is present in the particular location.
Aspect 7. The apparatus of any one of Aspects 1 to 6, wherein each location of a plurality of locations of the second cluster map includes a respective probability value, wherein a probability value for a particular location of the plurality of locations of the second cluster map indicates a probability that a respective prototype from the set of prototypes is present in the particular location.
Aspect 8. The apparatus of any one of Aspects 1 to 7, wherein the one or more processors are configured to: determine, using an assignment algorithm, an assignment between the set of prototypes and the first set of features for the source image: generate, based on the determined assignment, a modified cluster map for the source image; and determine the propagated cluster map for the source image using the modified cluster map and the correspondence between the plurality of regions of the source image and the plurality of regions of the target image.
Aspect 9. The apparatus of Aspect 8, wherein the assignment algorithm comprises a Sinkhorn-Knopp Assignment Algorithm.
Aspect 10. The apparatus of any one of Aspects 1 to 9, wherein each location of a plurality of locations of the first cluster map is associated with a respective region of the plurality of regions of the source image, and wherein each location of a plurality of locations of the second cluster map is associated with a respective region of the plurality of regions of the target image.
Aspect 11. The apparatus of any one of Aspects 1 to 10, wherein the one or more processors are configured to: determine the correspondence between the plurality of regions of the source image and the plurality of regions of the target image.
Aspect 12. The apparatus of Aspect 11, wherein, to determine the correspondence between the plurality of regions of the source image and the plurality of regions of the target image, the one or more processors are configured to: determine a subset of features from the second set of features that matches a subset of features from the first set of features within a matching threshold, wherein the subset of features from the second set of features is within a local window around a location in the second set of features relative to a corresponding location in the second set of features.
Aspect 13. A processor-implemented method of processing image data, the method comprising: processing, using a machine learning model, a source image to generate a first set of features for the source image: processing, using the machine learning model, a target image to generate a second set of features for the target image: generating a first cluster map for the source image based on a set of prototypes and the first set of features for the source image; generating a second cluster map for the target image based on the set of prototypes and the second set of features for the target image; determining a propagated cluster map for the source image based on the first cluster map and a correspondence between a plurality of regions of the source image and a plurality of regions of the target image; and determining a loss based on a comparison of the propagated cluster map for the source image and the second cluster map for the target image.
Aspect 14. The processor-implemented method of Aspect 13, further comprising: training at least a portion of the machine learning model based on the loss.
Aspect 15. The processor-implemented method of any one of Aspects 13 or 14, wherein the machine learning model is a dense self-supervised machine learning model.
Aspect 16. The processor-implemented method of any one of Aspects 13 to 15, wherein generating the first cluster map for the source image comprises: determining a dot product of the set of prototypes and the first set of features.
Aspect 17. The processor-implemented method of any one of Aspects 13 to 16, wherein generating the second cluster map for the target image comprises: determining a dot product of the set of prototypes and the second set of features.
Aspect 18. The processor-implemented method of any one of Aspects 13 to 17, wherein each location of a plurality of locations of the first cluster map includes a respective probability value, and wherein a probability value for a particular location of the plurality of locations of the first cluster map indicates a probability that a respective prototype from the set of prototypes is present in the particular location.
Aspect 19. The processor-implemented method of any one of Aspects 13 to 18, wherein each location of a plurality of locations of the second cluster map includes a respective probability value, wherein a probability value for a particular location of the plurality of locations of the second cluster map indicates a probability that a respective prototype from the set of prototypes is present in the particular location.
Aspect 20. The processor-implemented method of any one of Aspects 13 to 19, further comprising: determining, using an assignment algorithm, an assignment between the set of prototypes and the first set of features for the source image: generating, based on the determined assignment, a modified cluster map for the source image; and determining the propagated cluster map for the source image using the modified cluster map and the correspondence between the plurality of regions of the source image and the plurality of regions of the target image.
Aspect 21. The processor-implemented method of Aspect 20, wherein the assignment algorithm comprises a Sinkhorn-Knopp Assignment Algorithm.
Aspect 22. The processor-implemented method of any one of Aspects 13 to 21, wherein each location of a plurality of locations of the first cluster map is associated with a respective region of the plurality of regions of the source image, and wherein each location of a plurality of locations of the second cluster map is associated with a respective region of the plurality of regions of the target image.
Aspect 23. The processor-implemented method of any one of Aspects 13 to 22, further comprising: determining the correspondence between the plurality of regions of the source image and the plurality of regions of the target image.
Aspect 24. The processor-implemented method of Aspect 23, wherein determining the correspondence between the plurality of regions of the source image and the plurality of regions of the target image comprises: determining a subset of features from the second set of features that matches a subset of features from the first set of features within a matching threshold, wherein the subset of features from the second set of features is within a local window around a location in the second set of features relative to a corresponding location in the second set of features.
Aspect 25. A non-transitory computer-readable storage medium comprising instructions stored thereon which, when executed by one or more processors, causes the one or more processors to perform operations according to any of Aspects 13 to 24.
Aspect 26. An apparatus to process image data, comprising one or more means for performing operations according to any of Aspects 13 to 24.

1. An apparatus to process image data, the apparatus comprising:
one or more memories configured to store the image data; and
one or more processors coupled to the one or more memories and configured to: process, using a machine learning model, a source image of the image data to generate a first set of features for the source image;
process, using the machine learning model, a target image to generate a second set of features for the target image;
generate a first cluster map for the source image based on a set of prototypes and the first set of features for the source image;
generate a second cluster map for the target image based on the set of prototypes and the second set of features for the target image;
determine a propagated cluster map for the source image based on the first cluster map and a correspondence between a plurality of regions of the source image and a plurality of regions of the target image; and
determine a loss based on a comparison of the propagated cluster map for the source image and the second cluster map for the target image.

2. The apparatus of claim 1, wherein the one or more processors are configured to: train at least a portion of the machine learning model based on the loss.

3. The apparatus of claim 1, wherein the machine learning model is a dense selfsupervised machine learning model.

4. The apparatus of claim 1, wherein, to generate the first cluster map for the source image, the one or more processors are configured to:
determine a dot product of the set of prototypes and the first set of features.

5. The apparatus of claim 1, wherein, to generate the second cluster map for the target image, the one or more processors are configured to:
determine a dot product of the set of prototypes and the second set of features.

6. The apparatus of claim 1, wherein each location of a plurality of locations of the first cluster map includes a respective probability value, and wherein a probability value for a particular location of the plurality of locations of the first cluster map indicates a probability that a respective prototype from the set of prototypes is present in the particular location.

7. The apparatus of claim 1, wherein each location of a plurality of locations of the second cluster map includes a respective probability value, wherein a probability value for a particular location of the plurality' of locations of the second cluster map indicates a probability that a respective prototype from the set of prototypes is present in the particular location.

8. The apparatus of claim 1, wherein the one or more processors are configured to: determine, using an assignment algorithm, an assignment between the set of prototypes and the first set of features for the source image;
generate, based on the determined assignment, a modified cluster map for the source image; and
determine the propagated cluster map for the source image using the modified cluster map and the correspondence between the plurality of regions of the source image and the plurality of regions of the target image.

9. The apparatus of claim 8, wherein the assignment algorithm comprises a Sinkhom-Knopp assignment algorithm.

10. The apparatus of claim 1, wherein each location of a plurality of locations of the first cluster map is associated with a respective region of the plurality of regions of the source image, and wherein each location of a plurality of locations of the second cluster map is associated with a respective region of the plurality of regions of the target image.

11. The apparatus of claim 1, wherein the one or more processors are configured to: determine the correspondence between the plurality' of regions of the source image and the plurality of regions of the target image.

12. The apparatus of claim 11, wherein, to determine the correspondence between the plurality of regions of the source image and the plurality of regions of the target image, the one or more processors are configured to:
determine a subset of features from the second set of features that matches a subset of features from the first set of features within a matching threshold, wherein the subset of features from the second set of features is within a local window around a location in the second set of features relative to a corresponding location in the second set of features.

13. A processor-implemented method of processing image data, the method comprising:
processing, using a machine learning model, a source image to generate a first set of features for the source image;
processing, using the machine learning model, a target image to generate a second set of features for the target image;
generating a first cluster map for the source image based on a set of prototypes and the first set of features for the source image;
generating a second cluster map for the target image based on the set of prototypes and the second set of features for the target image;
determining a propagated cluster map for the source image based on the first cluster map and a correspondence between a plurality of regions of the source image and a plurality of regions of the target image; and
determining a loss based on a comparison of the propagated cluster map for the source image and the second cluster map for the target image.

14. The processor-implemented method of claim 13, further comprising:
training at least a portion of the machine learning model based on the loss.

15. The processor-implemented method of claim 13, wherein the machine learning model is a dense self-supervised machine learning model.

16. The processor-implemented method of claim 13, wherein generating the first cluster map for the source image comprises:
determining a dot product of the set of prototypes and the first set of features.

17. The processor-implemented method of claim 13, wherein generating the second cluster map for the target image comprises:
determining a dot product of the set of prototypes and the second set of features.

18. The processor-implemented method of claim 13, wherein each location of a plurality of locations of the first cluster map includes a respective probability value, and wherein a probability value for a particular location of the plurality of locations of the first cluster map indicates a probability that a respective prototype from the set of prototypes is present in the particular location.

19. The processor-implemented method of claim 13, wherein each location of a plurality of locations of the second cluster map includes a respective probability value, wherein a probability value for a particular location of the plurality of locations of the second cluster map indicates a probability that a respective prototype from the set of prototypes is present in the particular location.

20-24. (canceled)

25. A non-transitory computer-readable storage medium comprising instructions stored thereon which, when executed by one or more processors, causes the one or more processors to perform operations comprising:
processing, using a machine learning model, a source image to generate a first set of features for the source image;
processing, using the machine learning model, a target image to generate a second set of features for the target image;
generating a first cluster map for the source image based on a set of prototypes and the first set of features for the source image;
generating a second cluster map for the target image based on the set of prototypes and the second set of features for the target image;
determining a propagated cluster map for the source image based on the first cluster map and a correspondence between a plurality of regions of the source image and a plurality of regions of the target image; and
determining a loss based on a comparison of the propagated cluster map for the source image and the second cluster map for the target image.

26-30. (canceled)
